(19) United States
(12) Patent Application Publication
(10) Pub. No.: US 2024/0387840 A1
(43) Pub. Date: Nov. 21, 2024

(54) METHOD FOR PRODUCING A SEAL, SEALING ARRANGEMENT WITH SEAL, FUEL CELL AND FUEL CELL STACK

(71) Applicant: Robert Bosch GmbH, Stuttgart (DE)

(72) Inventors: Dominik Giersch, Eberdingen (DE); Matthias Musialek, Dossenheim (DE)

(21) Appl. No.: 18/694,023

(22) PCT Filed: Sep. 7, 2022
(86) PCT No.: PCT/EP2022/074826

§ 371 Date: Mar. 21, 2024

(30) Foreign Application Priority Data
Sep. 22, 2021 (DE) 10 2021 210 520.3

(51) Int. Cl. H01M 8/0286; H01M 8/0284; H01M 8/1004

(52) U.S. Cl. CPC H01M 8/0286; H01M 8/0284; H01M 8/1004

(57) ABSTRACT

The invention relates to a method for producing a seal (1) between two joining partners, preferably between a bipolar plate (2) and a membrane electrode arrangement (3) of a fuel cell, in which at least one sealant (4) is applied to one of the two joining partners. According to the invention, the seal (1) is hollow or filled with a filler material (5), wherein a filler material (5) is used which has a lower hardness, in particular Shore hardness, compared to the outer sealant (4).

The invention also relates to a sealing arrangement, a fuel cell with a sealing arrangement according to the invention and a fuel cell stack.

### BACKGROUND

The invention relates to a method for producing a seal between two joining partners according to the disclosure. Furthermore, the invention relates to a sealing arrangement with a seal which can be produced by the method according to the invention.

The two joining partners between which the seal is arranged can be, in particular, a bipolar plate and a membrane electrode arrangement of a fuel cell. The invention therefore also relates to a fuel cell with a sealing arrangement according to the invention. Furthermore, a fuel cell stack with a fuel cell according to the invention is proposed.

A fuel cell comprises several layers through which different media flow when the fuel cell is in operation. To ensure reliable separation of the different media, seals are therefore inserted between the multiple layers and/or the multiple layers are joined in a media-tight manner. For example, elastomer seals can be used, which are then pressed together during assembly.

The sealing materials for forming the seals can be applied using an injection molding process or dispensing process. Here, a sealant is applied to at least one of the respective joining partners before pressing. For the subsequent pressing process, it is advantageous if the sealant used is as soft as possible in order to be able to control the pressing process in a stable manner. However, the use of soft sealants also increases the permeability of the resulting seal, which is a disadvantage.

DE 10 2007 005 589 A1 discloses a seal for a fuel cell which has a core element and an edge element at least partially surrounding the core element, wherein the core element is harder than the edge element. Under pressure, therefore, only the edge element deforms, while the core element retains a defined shape and size. The harder core element also shows fewer signs of fatigue, so that the shape and size and thus the sealing function of the seal are maintained in the long term.

### SUMMARY

The present invention is concerned with the task of reducing permeation by seals which are at least partially made of soft sealants. In this way, the media tightness of fuel cells is to be optimized.

To solve the problem, the method and the sealing arrangement according to the disclosure are proposed. A fuel cell and a fuel cell stack are also specified.

In the proposed method for producing a seal between two joining partners, at least one sealant is applied to one of the two joining partners. In particular, the joining partners can be a bipolar plate and a membrane electrode arrangement of a fuel cell. According to the invention, the seal is hollow or filled with a filler material. A filler material is used that has a lower hardness, in particular Shore hardness, than the external sealant.

A seal produced using the proposed method is therefore either hollow or filled. This has the advantage that the seal can be made from a hard and therefore more permeation-tight sealant. The hollow space defined by the sealant and filled with gas or a filler material also enables a stable, force-controlled pressing process during the subsequent pressing of the two joining partners. Furthermore, the tolerance robustness of the seal increases.

If the seal is arranged between a bipolar plate and a membrane electrode arrangement of a fuel cell, efficiency can be increased during subsequent operation of the fuel cell thanks to the lower permeation. Several fuel cells of the same type can be connected to form a fuel cell stack, wherein the proposed method for producing the seal enables an efficient and robust stacking process. In addition, existing or known processes can be used for producing the seal, so that no changes need to be made to the system. The increased tolerance robustness of the individual seal also increases the tolerance robustness of the system.

To form a hollow seal, the sealant is preferably applied to a joining partner in such a way that the sealant-alone or together with the joining partner-encloses a hollow space. The hollow space is filled with gas, which may be air in particular.

To form a filled seal, the sealant-possibly together with the filler material—can be applied to a joining partner so that the sealant completely or partially encloses the filler material. Areas not enclosed by the sealant are preferably covered by the joining partner so that the filler material of the seal does not later come into contact with the medium that is applied to the space between the two joining partners. As an alternative to the simultaneous application of sealant and filler material, the filler material can also be applied to the joining partner first. The sealant is then applied to the joining partner and the filler material.

A filler material with a Shore hardness according to DIN EN ISO 868 of less than 30 ShA, preferably less than 20 ShA, is preferably used in the method.

In particular, another sealant, such as silicone, can be used as a filler material. This enables the use of conventional sealants as filler material, which are not sufficiently permeation-tight in themselves, but are protected from contact with the medium by the external sealant of the seal produced using the proposed method.

Foam or a foam-forming material can also be used as filler material. In this case, the comparatively low hardness can be adjusted via the respective structure of the filler material. In this case, the structure has a large number of gas-filled hollow spaces, so that the principle of a hollow seal is repeated many times.

An ethylene-propylene-diene rubber (EPDM), a fluororubber (FKM) or a thermoplastic elastomer (TPE) is preferably used as the external sealant. These sealants are sufficiently hard and therefore permeation-tight, so that a high level of gas tightness can be achieved. However, the comparatively high hardness of such sealants limits the possibilities for tolerance compensation, so that the robustness against tolerances is reduced. The Shore hardness of EPDM, for example, is around 40-50 ShA. This makes this sealant around four times as stiff as silicone.

In the method according to the invention, the conflict of objectives between a high gas tightness and a high tolerance robustness is solved by the fact that the seal is hollow or filled, wherein a softer filler material is used for filling compared to an external sealant of the seal. The optimum seal can therefore be created by suitably combining materials of different hardnesses. For example, a seal can be produced with a soft foamed core and a hard gas-tight outer shell.

According to a preferred embodiment of the invention, the sealant and/or the filler material is/are applied in a printing process, for example by means of stencil printing, in an injection molding process or in a dispensing process. These processes are fast and precise, making them particularly suitable for the large-scale production of fuel cells and fuel cell stacks.

Furthermore, it is suggested that the sealant and/or the filler material is/are applied strand by strand. The strand-by-strand application leads to the formation of a sealing strand, the course of which can be optimally adapted to the contour to be sealed. If the sealant and the filler material are applied to a joining partner in strands—with a time offset to each other—the filler material is preferably applied first and then the sealant is applied so that the sealant completely covers the filler material.

The sealing arrangement also proposed for solving the task mentioned at the beginning has a seal arranged between two joining partners, preferably between a bipolar plate and a membrane electrode arrangement of a fuel cell. According to the invention, the seal is hollow or filled with a filler material, wherein the filler material has a lower hardness, in particular Shore hardness, compared to an external sealant of the seal.

Due to the hollow or filled seal, the proposed sealing arrangement has a high gas tightness and at the same time a high tolerance robustness, two properties that usually contradict each other.

The seal of the proposed sealing arrangement is preferably produced according to any of the methods of the invention described above, so that the advantages associated with the method according to the invention are achieved. In particular, the seal can be produced quickly and precisely if, for example, a printing process, injection molding process or dispensing process is used to apply the sealant and/or the filler material. In addition, the sealants and/or filler materials described above in connection with the method according to the invention are particularly suitable for producing the seal.

If the seal of the sealing arrangement is filled, the filler material preferably has a Shore hardness according to DIN EN ISO 868 of less than 30 ShA, preferably less than 20 ShA. In particular, the filler material can be another sealant, for example a silicone and/or a foam. The external sealant is preferably an ethylene propylene diene rubber (EPDM), a fluororubber (FKM) or a thermoplastic elastomer (TPE). Suitable material pairings can be used to optimize the seal both in terms of permeability and tolerance robustness.

Furthermore, a fuel cell for a fuel cell stack with a sealing arrangement according to the invention is proposed. The seal is arranged between a bipolar plate and a membrane electrode arrangement of the fuel cell to seal a space to which a medium can be applied. The medium can in particular be a reaction gas, for example hydrogen or air. The hollow or filled seal can be used to join the bipolar plate and the membrane electrode arrangement in a media-tight manner. The sealing arrangement according to the invention has a high gas tightness and a high tolerance robustness. The high gas tightness increases the efficiency of the fuel cell.

Furthermore, a fuel cell stack with at least one fuel cell according to the invention is proposed. The high efficiency of the at least one fuel cell according to the invention is also transferred to the efficiency of the fuel cell stack.

### BRIEF DESCRIPTION OF THE DRAWINGS

Advantageous embodiments of the invention are explained in more detail below with reference to the accompanying drawings. Shown are:

FIG. 1 a simplified sectional view of an edge-reinforced membrane electrode arrangement with a seal produced by a method according to the invention, and

FIG. 2 a simplified sectional view of a bipolar plate with a seal produced by a method according to the invention.

### DETAILED DESCRIPTION

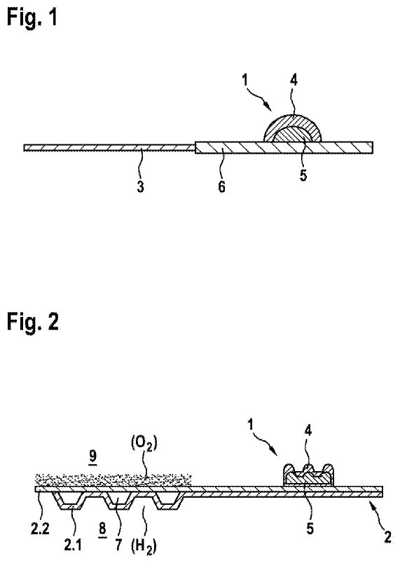

FIG. 1 shows a seal 1 which is arranged on an edge reinforcement 6 of a membrane electrode arrangement 3 for the production of a fuel cell. The seal 1 can be used to join the membrane electrode arrangement 3 to another joining partner, for example a bipolar plate (not shown), in a media-tight manner. The seal 1 has a filling made of a filler material 5, which is surrounded by a sealant 4. The sealant 4 has a greater hardness, in particular Shore hardness, than the filler material 5 and is therefore particularly gas-tight or permeation-tight. The lower hardness of the filler material 5 contributes to the tolerance robustness of the seal 1.

To produce the seal 1 of FIG. 1, the filler material 5 can first be applied to the edge reinforcement 6 of the membrane electrode arrangement 3. The application can take place using a printing, injection molding or dispensing process, for example. Once the filler material 5 has been applied, the sealant 4 can be applied over it so that the sealant 4 completely covers the filler material 5. The other joining partner can then be placed on the membrane electrode arrangement 3. Pressing then creates a media-tight connection between the two joining partners.

FIG. 2 shows another seal 1 with a sealant 4 and a filler material 5, wherein-analogous to the seal 1 in FIG. 1—the filler material 5 has a lower hardness, in particular Shore hardness, than the sealant 4. In this respect, the same advantages are achieved with the aid of seal 1 in FIG. 2 as with the aid of seal 1 in FIG. 1. In particular, two joining partners can be joined in a media-tight manner.

In FIG. 2, the seal 1 is arranged on a bipolar plate 2, so that the bipolar plate 2 represents a first joining partner. The bipolar plate 2 comprises at least one metal sheet 2.1, which is embossed to form cooling channels 7. The metal sheet 2.1 separates the cooling channels 7 from an area 8 that can be applied to a first reaction gas, namely hydrogen (H₂). The cooling channels 7 are separated from an area 9, which can be supplied with oxygen (O₂) as a further reaction gas, by a further metal sheet 2.2 of the bipolar plate 2. The seal 1 is arranged on the metal sheet 2.2, so that the area 9 is sealed gas-tight to the outside with the aid of the seal 1 when the bipolar plate 2 is connected, preferably pressed, to a membrane electrode arrangement (not shown). A further seal 1, comprising a sealant 4 and a filler material 5, can be arranged on the opposite side of the bipolar plate 2 or on the metal sheet 2.1, so that the area 8 is also sealed to the outside. The joining partner here can also be a membrane electrode arrangement 3, so that the bipolar plate 2 is arranged between two membrane electrode arrangements 3, for example to form a fuel cell stack comprising several fuel cells.

1. A method for producing a seal (1) between two joining partners in which a sealant (4) is applied to one of the two joining partners,
wherein the seal (1) is hollow or filled with a filler material (5), wherein the filler material (5) has a lower hardness compared to the sealant (4).

2. The method according to claim 1,
wherein the filler material (5) has a Shore hardness according to DIN EN ISO 868 of less than 30 ShA.

3. The method according to claim 1,
wherein a further sealant is used as the filler material (5).

4. The method according to claim 1,
wherein a foam or a foam-forming material is used as the filler material (5).

5. The method according to claim 1,
wherein an ethylene-propylene-diene rubber (EPDM), a fluororubber (FKM) or a thermoplastic elastomer (TPE) is used as the sealant (4).

6. The method according to claim 1,
wherein the sealant (4) and/or the filler material (5) is/are applied in a printing process, in an injection molding process or in a dispensing process.

7. The method according to claim 1,
wherein the sealant (4) and/or the filler material (5) is/are applied in strands.

8. A sealing arrangement with a seal (1) arranged between two joining partners,
wherein the seal (1) is hollow or filled with a filler material (5), wherein the filler material (5) has a lower hardness than an external sealant (4) of the seal (1).

9. The sealing arrangement according to claim 8,
wherein the filler material (5) has a Shore hardness according to DIN EN ISO 868 of less than 30 ShA.

10. The sealing arrangement according to claim 8,
wherein the filler material (5) is another sealant.

11. The sealing arrangement according to claim 8,
wherein the external sealant (4) is an ethylene-propylene-diene rubber (EPDM), a fluororubber (FKM) or a thermoplastic elastomer (TPE).

12. A fuel cell for a fuel cell stack with a sealing arrangement according to claim 8, wherein the seal (1) is arranged between a bipolar plate (2) and a membrane electrode arrangement (3) of the fuel cell for sealing a space to which a medium can be applied.

13. A fuel cell stack with at least one fuel cell according to claim 12.

14. The method according to claim 1, wherein the two joining partners are a bipolar plate (2) and a membrane electrode arrangement (3) of a fuel cell.

15. The method according to claim 2, wherein the filler material (5) has a Shore hardness according to DIN EN ISO 868 of less than 20 ShA.

16. The method according to claim 3, wherein the further sealant is silicone.

17. The method according to claim 6, wherein the printing process includes stencil printing.

18. The sealing arrangement according to claim 8, wherein the two joining partners are a bipolar plate (2) and a membrane electrode arrangement (3) of a fuel cell.

19. The sealing arrangement according to claim 9, wherein the filler material (5) has a Shore hardness according to DIN EN ISO 868 of less than 20 ShA.

20. The sealing arrangement according to claim 10, wherein the further sealant is silicone and/or a foam.
